(19) United States
(12) Patent Application Publication
(10) Pub. No.: US 2026/0042290 A1
(43) Pub. Date: Feb. 12, 2026

(54) LIQUID EJECTION HEAD AND METHOD FOR MANUFACTURING LIQUID EJECTION HEAD

(71) Applicant: CANON KABUSHIKI KAISHA, Tokyo (JP)

(72) Inventors: RYO SHIMAMURA, Kanagawa (JP); HIROKI TAJIMA, Kanagawa (JP); TAKEHO MIYASHITA, Kanagawa (JP); RYO SATO, Kanagawa (JP); TAKURO INABA, Kanagawa (JP); ISAMU YONEDA, Kanagawa (JP)

(21) Appl. No.: 19/279,538

(22) Filed: Jul. 24, 2025

(30) Foreign Application Priority Data
Aug. 6, 2024 (JP) 2024-129865

(51) Int. Cl. B41J 2/14; B41J 2/16

(52) U.S. Cl. CPC B41J 2/14024; B41J 2/14072; B41J 2/1601; B41J 2/1623

(57) ABSTRACT

A liquid ejection head with improved reliability has an element substrate configured to eject a liquid according to an electric signal; a support member supporting the element substrate; and a flexible wiring substrate fixed to the support member and configured to supply the electric signal to the element substrate. On a surface of the support member supporting the element substrate, the flexible wiring substrate includes a fixed portion fixed to the support member by an adhesive agent and a non-fixed portion not fixed to the support member. The flexible wiring substrate is bent from a position included in the non-fixed portion as a starting point.

### BACKGROUND

### Field of the Technology

The present disclosure relates to a liquid ejection head and a method for manufacturing a liquid ejection head.

### Description of the Related Art

The manufacturing of a liquid ejection head that ejects liquids sometimes involves bending a flexible wiring substrate having flexibility in conformity with the shape of a housing and attaching the flexible wiring substrate to the housing.

Japanese Patent Laid-Open No. 2015-093452 discloses a liquid ejection head including a housing in which a recess is formed and an electric wiring substrate (flexible wiring substrate) which is bent and fixed to the housing, and also discloses a method for manufacturing the same.

According to the manufacturing method of Japanese Patent Laid-Open No. 2015-093452, a warped portion of the electric wiring substrate is accommodated inside the recessed formed in the housing in a step of attaching the electric wiring substrate to the housing. Thus, the manufacturing method disclosed in Japanese Patent Laid-Open No. 2015-093452 and the liquid ejection head manufactured by this manufacturing method can prevent floating of the electric wiring substrate fixed to the housing. This further prevents a floating portion of the electric wiring substrate from contacting other parts and impairing the electrical safety of the liquid ejection head.

The housing in Japanese Patent Laid-Open No. 2015-093452 has a surface to which a printing element substrate (element substrate) is attached, and the electric wiring substrate is bonded to this surface of the housing by an adhesive agent. In a case where the adhesive agent protrudes from the housing due to some reason when the adhesive agent is applied, the electric wiring substrate will be bent on the protruding portion of the applied adhesive agent as a starting point. In a case where the electric wiring substrate is bent in such a state, the electric wiring substrate will be attached to the housing with the above-described floating occurring on the electric wiring substrate. Thus, the technique of Japanese Patent Laid-Open No. 2015-093452 still has room for improvement.

Bending the electric wiring substrate on the adhesive agent as a starting point exerts an excessive stress on the electric wiring substrate and leads to a possibility of breakage of the electric wiring substrate. The breakage of the electric wiring substrate leads to electrical problems.

### SUMMARY

The present disclosure advantageously provides a technique capable of improving reliability of a flexible wiring substrate.

A liquid ejection head according to some embodiments of the present disclosure has an element substrate configured to eject a liquid according to an electric signal; a support member supporting the element substrate; and a flexible wiring substrate fixed to the support member and configured to supply the electric signal to the element substrate. On a surface of the support member supporting the element substrate, the flexible wiring substrate includes a fixed portion fixed to the support member by an adhesive agent and a non-fixed portion not fixed to the support member. The flexible wiring substrate is bent from a position included in the non-fixed portion as a starting point.

Features of the present disclosure will become apparent from the following description of embodiments with reference to the attached drawings. The following description of embodiments are described by way of example.

### BRIEF DESCRIPTION OF THE DRAWINGS

FIG. 1A is a schematic perspective view illustrating an example of a liquid ejection apparatus in an embodiment.

FIG. 1B is a block diagram of a control system of a liquid ejection apparatus in an embodiment.

FIG. 2 is an exploded perspective view illustrating an example of a liquid ejection head in an embodiment.

FIG. 3A is a schematic perspective view of a liquid ejection head in an embodiment as seen from a contact wiring substrate side.

FIG. 3B is a schematic perspective view of a liquid ejection head in an embodiment as seen from a connecting member side.

FIG. 4A is a cross-sectional view along the IVa-IVa line in FIG. 3A.

FIG. 4B is an enlarged view of the region IVb in FIG. 4A.

FIG. 5 is a cross-sectional view illustrating an example of a flexible wiring substrate in an embodiment.

FIG. 6 is a flowchart illustrating an example of a process of manufacturing a liquid ejection head in an embodiment.

FIG. 7A is a view illustrating how a process of manufacturing a liquid ejection head in an embodiment is performed.

FIG. 7B is a view illustrating how a process of manufacturing a liquid ejection head in an embodiment is performed.

FIG. 7C is a view illustrating how a process of manufacturing a liquid ejection head in an embodiment is performed.

FIG. 7D is a view illustrating how a process of manufacturing a liquid ejection head in an embodiment is performed.

FIG. 7E is a view illustrating how a process of manufacturing a liquid ejection head in an embodiment is performed.

FIG. 7F is a view illustrating how a process of manufacturing a liquid ejection head in an embodiment is performed.

FIG. 8A is a schematic cross-sectional view of a head unit in a reference example.

FIG. 8B is a schematic cross-sectional view illustrating a reference example of the head unit in a state where a flexible wiring substrate is bent with an adhesive agent protruding.

FIG. 8C is a view illustrating a reference example of breakage of the flexible wiring substrate.

FIG. 9A is a view illustrating a modification of a liquid ejection head in an embodiment.

FIG. 9B is a view illustrating a modification of a liquid ejection head in an embodiment.

FIG. 9C is a view illustrating a modification of a liquid ejection head in an embodiment.

FIG. 9D is a view illustrating a modification of a liquid ejection head in an embodiment.

FIG. 10 is a cross-sectional view illustrating an example of a liquid ejection head in an embodiment.

FIG. 11A is a schematic plan view of a liquid ejection head in an embodiment.

FIG. 11B is a schematic view of a process of applying an adhesive agent in an embodiment.

FIG. 11C is a bottom view of a cover member and a flexible wiring substrate in an embodiment.

FIG. 12A is a schematic plan view of a liquid ejection head in a modification.

FIG. 12B is a schematic view of a process of applying an adhesive agent in a modification.

FIG. 12C is a bottom view of a cover member and a flexible wiring substrate in a modification.

FIG. 13A is a schematic cross-sectional view of a liquid ejection head in an embodiment.

FIG. 13B is a schematic cross-sectional view of a liquid ejection head in an embodiment.

### DESCRIPTION OF THE EMBODIMENTS

### First Embodiment

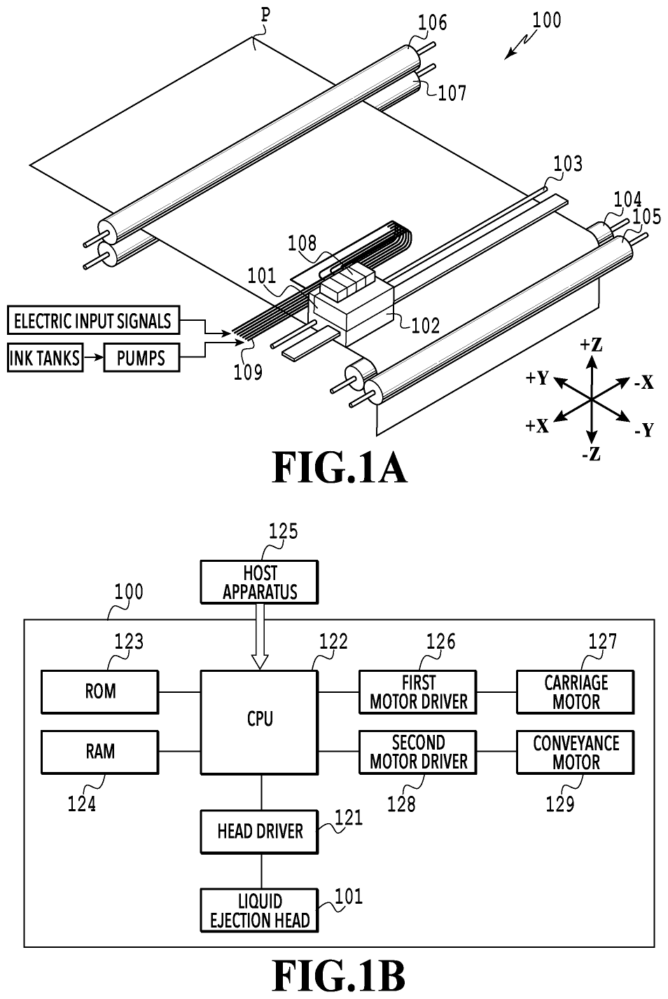

FIG. 1A is a schematic perspective view illustrating an embodiment of a liquid ejection apparatus 100 applicable to a first embodiment. FIG. 1B is a block diagram of a control system of the liquid ejection apparatus 100.

The coordinate axes in drawings will now be described. The ±X direction represents the main scanning direction of a liquid ejection head 101. The +Y direction is the conveyance direction of a print medium P. The +Y direction will be referred to also as “conveyance direction” as appropriate. The −Y direction is the opposite of the +Y direction. The Z direction represents the height direction of the liquid ejection head 101. The −Z direction is a direction in which liquids (e.g., inks) are ejected from the liquid ejection head 101. The +Z direction is the opposite of the −Z direction. In a state where the liquid ejection head 101 is mounted on the apparatus, the ±X direction is the width direction of the liquid ejection head 101, the ±Y direction is the depth direction of the liquid ejection head 101, and the ±Z direction is the height direction of the liquid ejection head 101.

The present embodiment will be described on the assumption that inks are used as the liquids. However, the liquids usable in the technique of the present disclosure are not limited to inks. As the liquids, various types of print liquids other than inks are usable, such as process liquids to be used to improve the fixability of inks on the print medium P, reduce gloss unevenness of the inks, and improve the scratch resistance of the inks.

The liquid ejection apparatus 100 illustrated in FIG. 1A is a serial scan-type inkjet printer that prints an image or the like on the print medium P by causing the liquid ejection head 101 to eject the inks while making a scanning movement. The liquid ejection head 101 is mounted on a carriage 102. The carriage 102 moves in the main scanning direction (±X direction) along a guide shaft 103. The print medium P is conveyed in the conveyance direction (+Y direction) crossing (in this example, orthogonally crossing) the main scanning direction by conveyance rollers 104, 105, 106, and 107.

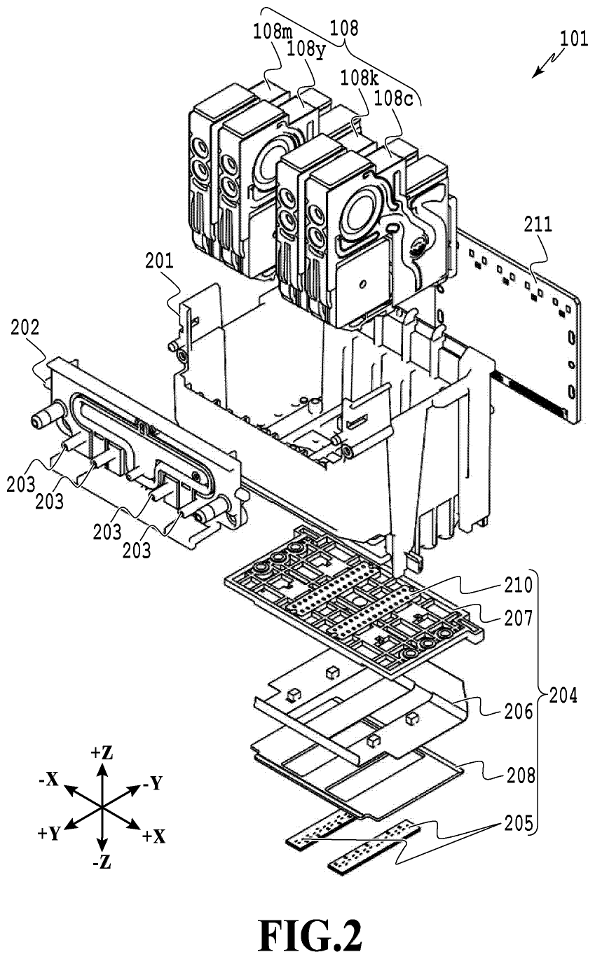

The liquid ejection head 101 is equipped with circulation units 108, with which the liquids are circulated through a later-described ejection unit 204 (see FIG. 2). A head driver 121 drives printing elements (described later) included in the ejection unit 204 according to input signals received by a contact wiring substrate 211 (see FIG. 2) from the main body. Electric wirings and liquid pipes used for ejection are supplied to the carriage 102 along a guide 109.

A central processing unit (CPU) 122 that functions as a control unit controls the liquid ejection apparatus 100 based on a program, such as the procedures of processes, stored in a read-only memory (ROM) 123. A random-access memory (RAM) 124 is used as a work area or the like for executing those processes. The CPU 122 controls the head driver 121 based on image data from a host apparatus 125 located outside the liquid ejection apparatus 100.

Also, the CPU 122 controls a carriage motor 127 for moving the carriage 102 through a first motor driver 126. The CPU 122 controls a conveyance motor 129 for conveying the print medium P through a second motor driver 128.

The liquid ejection head 101 is configured to be capable of performing full-color printing with cyan, magenta, yellow, and black (CMYK) inks. Examples of the liquids to be ejected by the liquid ejection head 101 are not limited to these. The liquid ejection head 101 may be configured to eject a white ink, a reaction liquid, and so on or to eject only a black ink.

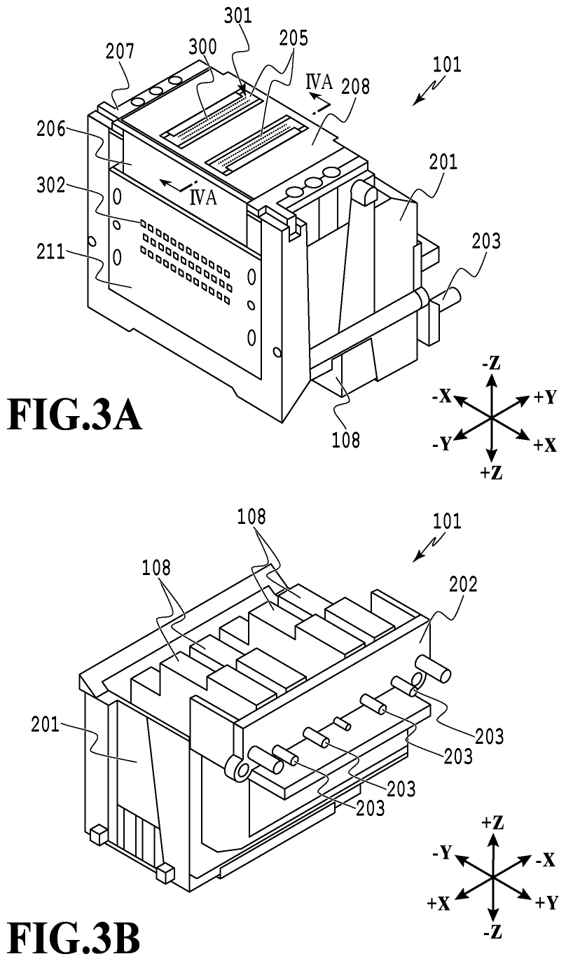

A cap member (not illustrated) is disposed at a position outside the conveyance path for the print medium P. While no liquid ejection operation is performed, this cap member is relatively moved to a position at which it covers the orifice face of the liquid ejection head 101. A suction operation is performed with the orifice face covered by the cap member for prevention of drying in ejection orifices 300 (see FIG. 3A), filling, and recover.

FIG. 2 is a schematic exploded perspective view of the liquid ejection head 101 applicable to the present embodiment as seen from a connecting member 202 side.

As illustrated in FIG. 2, the liquid ejection head 101 has the circulation units 108. The circulation units 108 include circulation units 108m, 108y, 108k, and 108c for the magenta, yellow, black, and cyan inks, respectively.

The circulation units 108 are connected to a channel member 201 that functions as a housing for the liquid ejection head 101. The circulation units 108 and the channel member 201 can be connected by any connecting method. For example, the circulation units 108 and the channel member 201 can be connected by screwing with a sealing member interposed between the circulation units 108 and the channel member 201, welding, or the like. The connecting member 202, which has supply ports 203 for receiving liquids from the main body of the apparatus, is mounted to the channel member 201. The connecting member 202 communicates with each circulation unit 108 (108m, 108y, 108k, and 108c).

In a state where the liquid ejection head 101 is mounted to the main body of the apparatus, the supply ports 203 are connected to supply tubes (not illustrated) corresponding to the types of the liquids to be ejected. The supply tubes are included in the guide 109 (see FIG. 1A). The liquids supplied from these supply tubes are supplied to the respective circulation units 108 through the connecting member 202. The ejection unit 204 is connected to the bottom surface of the channel member 201 (the surface in the −Z direction). The liquids supplied to the circulation units 108 are supplied to the ejection unit 204 through the channel member 201.

The ejection unit 204 can be fixed to the channel member 201 by any method. For example, the ejection unit 204 may be bonded to the channel member 201 with an adhesive agent or screwed to the channel member 201 with a sealing member interposed therebetween.

The ejection unit 204 includes: element substrates 205 including printing elements that generate energy for ejecting the liquids; a cover member 208 covering a flexible wiring substrate 206; and the flexible wiring substrate 206, which has flexibility. The ejection unit 204 includes a support member 207 supporting the element substrates 205 and the flexible wiring substrate 206. In the support member 207, channels 210 are formed through which the liquids are supplied from the circulation units 108 to the element substrates 205.

Electric signals sent to the contact wiring substrate 211 from the main body of the apparatus are sent the element substrates 205 through the flexible wiring substrate 206. Openings through which to expose the element substrates 205 are formed at portions of the cover member 208 corresponding to the element substrates 205. Openings are formed at portions of the flexible wiring substrate 206 corresponding to the element substrates 205. The element substrates 205 are bonded such that they are located inside these openings. In the configuration of the present embodiment illustrated in FIG. 2, the element substrates 205 are not covered by the cover member 208.

FIG. 3A is a schematic perspective view of the liquid ejection head 101 applicable to the present embodiment as seen from the contact wiring substrate 211 side. Note that, in FIG. 3A, the liquid ejection surface is oriented in an upward direction in the figure.

In the element substrates 205 illustrated in FIG. 3A, multiple printing elements for ejecting the liquids and electric wirings for supplying electric power to the printing elements are formed in a silicon substrate by a film forming technique. Multiple channels and multiple ejection orifices 300 corresponding to these printing elements are formed by a photolithographic technique. Multiple ejection orifices 300 are disposed along the Y direction to form an ejection orifice array 301. Also, liquid supply ports (openings) for supplying the liquids to the multiple ejection orifice arrays 301 are formed in the back surfaces of the element substrates 205 (in FIG. 3A the surfaces facing the +Z direction). As many liquid supply ports as the types of the liquids to be ejected are formed.

Also, these liquid supply ports in the element substrates 205 and spaces formed in the support member 207 form liquid chambers (not illustrated) for holding the liquids.

In the present embodiment, multiple (two in particular) element substrates 205 are attached to the support member 207. Each of these element substrates 205 is configured to be capable of ejecting multiple types of liquids. In each element substrate 205, multiple ejection orifices 300 that eject the corresponding liquids are formed. Printing elements (e.g., electrothermal conversion elements) are provided in such a manner as to correspond to these ejection orifices 300. Examples of the electrothermal conversion elements include heaters.

The element substrates 205 and the flexible wiring substrate 206 are electrically connected. Note that the support member 207 supports the element substrates 205 and the flexible wiring substrate 206 in such a manner as to maintain the electrical connection between the flexible wiring substrate 206 and the element substrates 205. The flexible wiring substrate 206 is electrically connected to the contact wiring substrate 211. As a result, in the present embodiment, the flexible wiring substrate 206 and the contact wiring substrate 211 form an electric wiring portion.

The contact wiring substrate 211 includes terminals 302 for receiving electric signals input from the main body of the apparatus (e.g., contact pads that function as electric contacts). The contact wiring substrate 211 is positioned on and fixed to the back side of the channel member 201 (in FIG. 3A the side facing the −Y direction). The channel member 201 is molded as a single piece, in which channels (not illustrated) to be connected to the channels 210 (see FIG. 2) are formed. Also, electric signals for ejecting the liquids are input from the main body of the apparatus into the element substrates 205 through the contact wiring substrate 211 and the flexible wiring substrate 206.

FIG. 3B is a schematic perspective view of the liquid ejection head 101 applicable to the present embodiment as seen from the connecting member 202 side. Note that, in FIG. 3B, the liquid ejection surface is oriented in a downward direction in the figure.

As illustrated in FIG. 3B, the circulation units 108 are detachably mounted to the channel member 201. The connecting member 202, which includes channels to be connected to the circulation units 108, is mounted to the channel member 201.

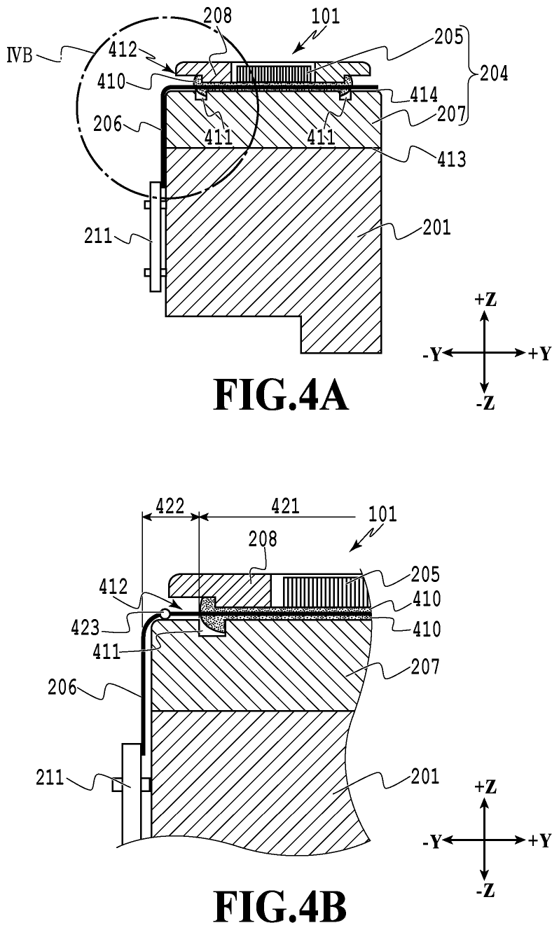

FIG. 4A is a cross-sectional view along the IVa-IVa line in FIG. 3. In the following description, the bottom surface of the liquid ejection head 101 (liquid ejection surface) is oriented in an upward direction in the figure (+Z direction) for convenience of description.

As illustrated in FIG. 4A, the liquid ejection head 101 includes the element substrates 205, which eject the liquids according to externally supplied electric signals, the support member 207, which supports the element substrates 205, and the flexible wiring substrate 206. The flexible wiring substrate 206 is fixed to the support member 207 in a state where the flexible wiring substrate 206 is bent along the support member 207.

The support member 207 has a first support surface 413 that supports the channel member 201 (in FIG. 4A the surface facing the −Z direction) and a second support surface 414 that supports the flexible wiring substrate 206 (in FIG. 4A the surface facing the +Z direction). An adhesive agent 410 is applied to part of the second support surface 414 to bond the support member 207, the flexible wiring substrate 206, the element substrates 205, and the cover member 208.

FIG. 4B is an enlarged view of the region IVb in FIG. 4A.

As illustrated in FIG. 4B, on the surface of the support member 207 supporting the element substrates 205, the flexible wiring substrate 206 includes a fixed portion 421 fixed to the support member 207 by the adhesive agent 410 and a non-fixed portion 422 not fixed to the support member 207. The flexible wiring substrate 206 is bent from a position included in the non-fixed portion 422 as a starting point 423. Note that, in the present embodiment, the starting point means a point at which the flexible wiring substrate 206 extending straight along a predetermined direction (in the present embodiment the Y direction) starts bending.

The cover member 208, which covers the flexible wiring substrate 206 and does not cover the element substrates 205, is bonded to the flexible wiring substrate 206 with the adhesive agent 410. Specifically, the cover member 208 has openings through which to expose the element substrates 205. A space 412 capable of accommodating the adhesive agent 410 is formed in the cover member 208. In a cross-sectional view of the liquid ejection head 101, part of the space 412 and part of the fixed portion 421 overlap in the height direction (Z direction).

In the present embodiment, the space 412 is a cutaway (recess) in the cover member 208 formed such that the surface of the cover member 208 facing the flexible wiring substrate 206 is farther away from the flexible wiring substrate 206 in the +Z direction. The space 412 is formed near the starting point 423. For example, the recess in the cover member 208 is formed to be located between the starting point 423 and the element substrates 205 in a direction parallel to the first support surface 413.

A groove 411 capable of accommodating the adhesive agent 410 is preferably formed in the support member 207 between the fixed portion 421 and the non-fixed portion 422. In a cross-sectional view of the liquid ejection head 101, the groove 411 overlaps the fixed portion 421 in the height direction of the liquid ejection head 101 (Z direction). With this configuration, the groove 411 accommodates an excess portion of the adhesive agent 410. In other words, it is possible to prevent the adhesive agent 410 from getting attached to the non-fixed portion 422.

The present inventors applied the adhesive agent 410 in a process of attaching the cover member 208 expecting to applying the adhesive agent in a maximum amount (width=1.2 mm, height=0.3 mm (millimeter)). The present inventors then confirmed that attaching the cover member 208 having a recess (depth=0.3 mm, width=1.2 mm) to the support member 207 did not make the adhesive agent 410 protrude onto the non-fixed portion 422.

The depth (the length in the Y direction) of the recess is preferably 2.0 mm or more, and the height (the length in the Z direction) of the recess is preferably 0.3 mm or more and 0.5 mm or less. With this configuration, the adhesive agent 410 will be accommodated in the space 412 even in a case where the adhesive agent 410 is applied in excess due to some reason. In other words, it is possible to prevent the adhesive agent 410 from getting attached to the non-fixed portion 422. The adhesive agent 410 includes a thermosetting material, for example. The adhesive agent 410 is fixed by curing through heating at a predetermined temperature.

In the present embodiment, an epoxy resin material whose hardness after being cured is relatively high is used as the adhesive agent 410. The Shore D hardness of this epoxy resin material is 60 Hs or more. This epoxy resin material becomes cured by being heated at 120° C. for 3 minutes or more. The above configuration is effective particularly in a case where the hardness of the adhesive agent 410 after being cured is high.

Also, the present inventors have confirmed that the adhesive agent 410 does not protrude onto the non-fixed portion 422 in a state where the flexible wiring substrate 206 is bonded to the support member 207 with the groove 411 formed near the starting point 423. In the present embodiment, the depth (the length in the Z direction) of the groove 411 is 0.3 mm, and the width (the length in the Y direction) of the groove 411 is 0.8 mm. However, the size of the groove 411 is not limited to this size.

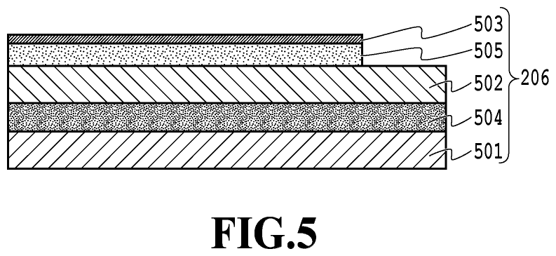

FIG. 5 is a schematic cross-sectional view of the flexible wiring substrate 206 applicable to the present embodiment.

As illustrated in FIG. 5, the flexible wiring substrate 206 is a multilayer structure. The flexible wiring substrate 206 includes a base film layer 501 containing a polyimide, a copper foil 502, and a cover film layer 503 containing MICTRON (registered trademark).

A first adhesive agent layer 504 is present between the base film layer 501 and the copper foil 502. The first adhesive agent layer 504 bonds the base film layer 501 and the copper foil 502 to each other. A second adhesive agent layer 505 is present between the copper foil 502 and the cover film layer 503. The second adhesive agent layer 505 bonds the copper foil 502 and the cover film layer 503 to each other.

The thickness (the length in the Z direction) of the base film layer 501 at the portion of the flexible wiring substrate 206 bonded to the second support surface 414 (see FIG. 4) is approximately 50.0 μm (micrometer), for example. The thickness (the length in the Z direction) of the copper foil 502 at the portion of the flexible wiring substrate 206 bonded to the second support surface 414 is approximately 35.0 μm, for example. The thickness (the length in the Z direction) of the cover film layer 503 at the portion of the flexible wiring substrate 206 bonded to the second support surface 414 is approximately 4.4 μm, for example.

Note that the flexible wiring substrate 206 may be a structure in which the above-described configuration is laminated in two layers.

### Method for Manufacturing Liquid Ejection Head 101

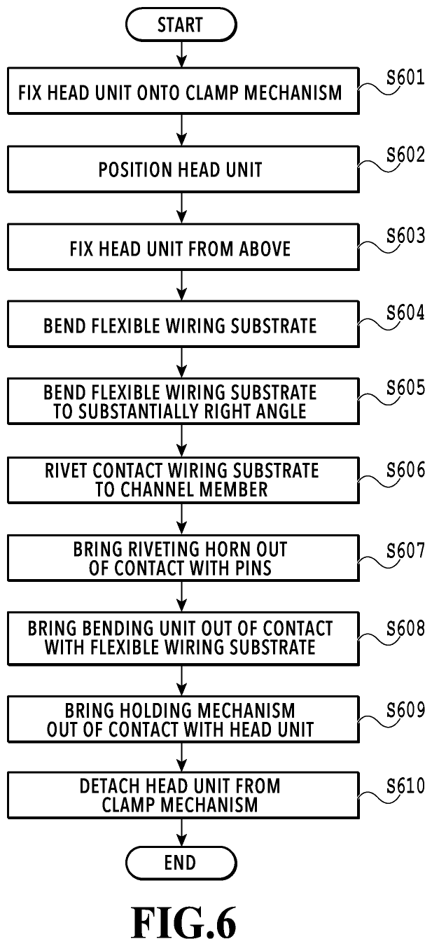

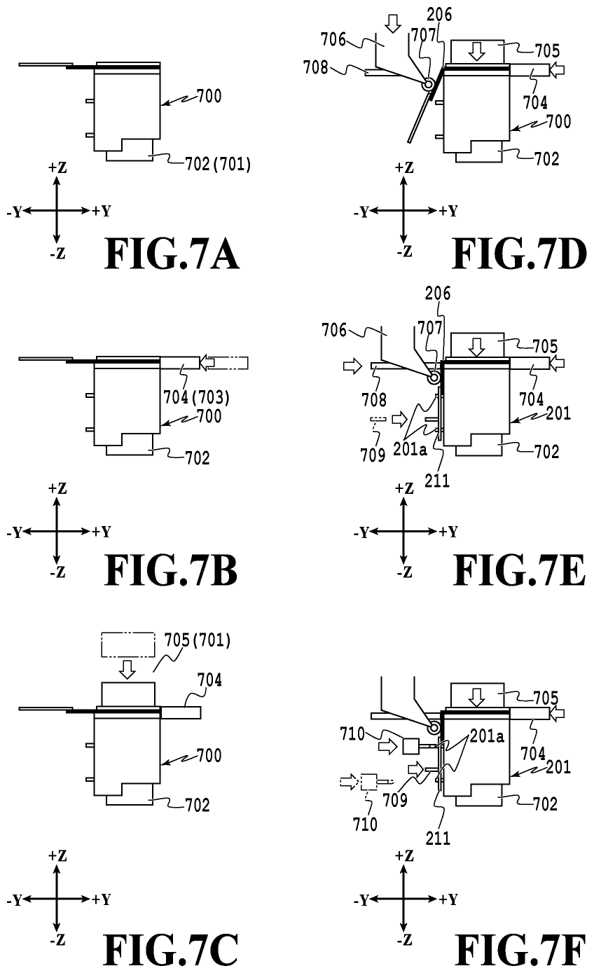

FIG. 6 is a flowchart illustrating a process of manufacturing the liquid ejection head 101 in the present embodiment. Also, FIGS. 7A to 7F are diagrams for describing steps. The steps in FIG. 6 will now be described below with reference to FIGS. 7A to 7F. Note that each symbol “S”in the following description means a step.

The following manufacturing process is executed based on the premise that: the flexible wiring substrate 206 and the contact wiring substrate 211 are already connected to each other; the flexible wiring substrate 206 and the element substrates 205 are already bonded to the support member 207; a sealing agent is already applied to electric connection portions; and the applied adhesive agent and sealing agent are already cured by heating.

Also, in the following description, the liquid ejection head 101 in a state where the contact wiring substrate 211 and the channel member 201 are yet to be fixed will be referred to as “head unit 700 (see FIGS. 7A to 7D)”for convenience of description.

In S601, as illustrated in FIG. 7A, the head unit 700 is fixed onto a clamp mechanism 702 of a backup unit 701.

In S602, as illustrated in FIG. 7B, a backup mechanism 704 of a support unit 703 is brought into contact with the head unit 700. The head unit 700 is positioned by the backup unit 701 and the backup mechanism 704.

In S603, as illustrated in FIG. 7C, a holding mechanism 705 of the backup unit 701 is lowered to fix the head unit 700 from above.

In S604, as illustrated in FIG. 7D, a roller 707 of a bending unit 706 is brought into contact with the flexible wiring substrate 206 while the head unit 700 is fixed from above to bend the flexible wiring substrate 206.

In S605, as illustrated in FIG. 7E, a bending block 708 is pressed against the flexible wiring substrate 206 to bend the flexible wiring substrate 206 to a substantially right angle. Bending the flexible wiring substrate 206 to a substantially right angle allows relative insertion of each of multiple pins 201a provided on the channel member 201 into a corresponding one of multiple elongated holes provided in the contact wiring substrate 211. At this time, a positioning member 709 contacts the contact wiring substrate 211, thereby positioning the contact wiring substrate 211.

In the present embodiment, S605 precedes a step of riveting the contact wiring substrate 211 (S606). This enables the flexible wiring substrate 206 to be fixed in a state where the reaction acting on its bent portion is suppressed while vertical movement of the flexible wiring substrate 206 may be restricted within the range of the above-mentioned elongated holes.

In S606, as illustrated in FIG. 7F, the contact wiring substrate 211 is riveted to the channel member 201. The number of riveting positions may be at least two. In the present embodiment, the pins 201a protrude from two positions on each of upper and lower sides of the channel member 201, i.e., a total of four pins 201a protrude from the channel member 201. These four pins 201a is relatively inserted into four elongated holes formed in the contact wiring substrate 211, respectively. The pins 201a fitted in the elongated holes are riveted by a riveting horn 710. Such riveting fixes the contact wiring substrate 211 to the channel member 201.

Incidentally, of the sets of two pins 201a present on the upper and lower sides, the two pins 201a present on the upper side may be riveted before the two pins 201a present on the lower side. Alternatively, the two pins 201a present on the lower side may be riveted before the two pins 201a present on the upper side.

In S607, the riveting horn 710 is brought out of contact with the pins 201a.

In S608, the bending unit 706 is brought out of contact with the flexible wiring substrate 206.

In S609, the holding mechanism 705 is brought out of contact with the head unit 700.

In S610, the head unit 700 is detached from the clamp mechanism 702. As a result, the head unit 700 is released from being fixed by the backup unit 701.

Through the above steps, the flexible wiring substrate 206 is bent in such a manner as not to break, and the contact wiring substrate 211 is riveted to the channel member 201.

### Reference Example

To facilitate the understanding of the advantage of the non-fixed portion 422 (see FIG. 4) in the present embodiment, a description will now be given below by presenting a reference example. The liquid ejection apparatus incorporates various parts (e.g., sheet conveyance rollers not illustrated and so on).

Without the flexible wiring substrate 206 (see FIG. 2 and other drawings) bent at a substantially right angle, there is a possibility that the flexible wiring substrate 206 may contact these parts. To prevent this contact, it is important to bend the flexible wiring substrate 206 without floating thereof.

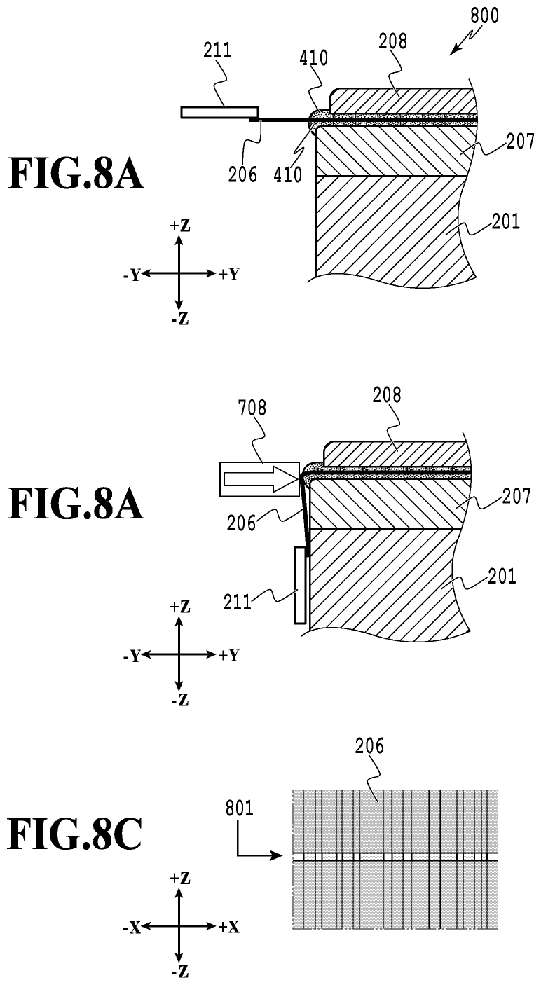

FIG. 8A is a schematic cross-sectional view of a head unit 800 in a reference example. Note that similar components in FIG. 8A to those in the present embodiment will be denoted by similar names to those in the present embodiment and description thereof will be omitted, and different components from those in the present embodiment will be mainly described.

As illustrated in FIG. 8A, on the upper surface of the support member 207, the flexible wiring substrate 206 of the head unit 800 is not provided with the non-fixed portion 422 (see FIG. 4) not fixed to the support member 207. In a case where the adhesive agent 410 is applied between the support member 207 and the cover member 208 with the flexible wiring substrate 206 therebetween without providing the non-fixed portion 422, the adhesive agent 410 may protrude from the support member 207.

FIG. 8B is schematic cross-sectional view illustrating a reference example of the head unit 800 in a state where the flexible wiring substrate 206 is bent with the adhesive agent 410 protruding.

In a case where the flexible wiring substrate 206 is bent at an acute angle on the protruding portion of the adhesive agent 410 as a starting point as illustrated in FIG. 8B, there is a possibility that an excessive tensile stress may be exerted on the front surface of the flexible wiring substrate 206 and break the flexible wiring substrate 206.

FIG. 8C is a view illustrating an embodiment of the breakage of the flexible wiring substrate 206.

As illustrated in FIG. 8C, in a case where the flexible wiring substrate 206 is bent while an excessive tensile stress is exerted thereon, there is a possibility that a crack 801 may be formed in the front surface of the flexible wiring substrate 206. The formation of the crack 801 in the flexible wiring substrate 206 leads to a possibility of an electrical failure (e.g., a short circuit or the like).

As described above, in the present embodiment, in a case of bonding the support member 207 and the cover member 208 with the flexible wiring substrate 206 therebetween, the non-fixed portion 422, to which the adhesive agent 410 is not applied, is provided. In a case of bending the flexible wiring substrate 206, the flexible wiring substrate 206 can be bent from a predetermined position within the non-fixed portion 422 as the starting point 423 for the bending. This configuration prevents the flexible wiring substrate 206 from being bent to an acute angle from a protruding portion of the adhesive agent 410 as a starting point.

Thus, the liquid ejection head of the present disclosure can improve reliability of its flexible wiring substrate.

Further, the groove 411 and the space 412 are formed within the range of in the fixed portion 421, which is located closer to the element substrates 205 than the non-fixed portion 422 is. This configuration allows an excess portion of the adhesive agent 410 to escape into the groove 411 or the space 412 or both of them.

Forming the groove 411 and the space 412 as above also makes it possible to increase the margin for the amount of the adhesive agent to be applied as compared to a case of not forming the groove 411 and the space 412.

### Modifications

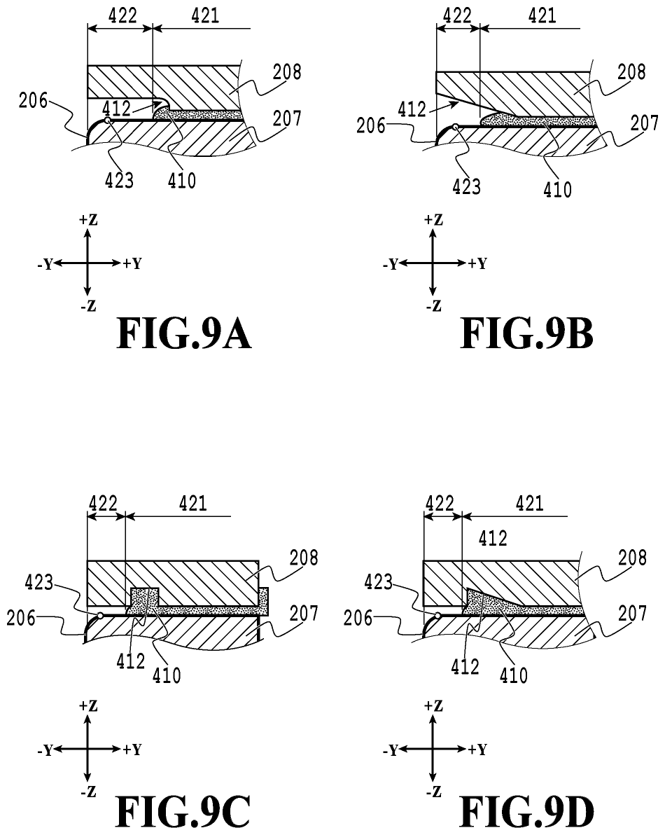

FIG. 9A is a view illustrating a first modification of the present embodiment.

As illustrated in FIG. 9A, the space 412 may be formed by a recess having a curved shape. This recess is provided at an outer edge of the cover member 208.

FIG. 9B is a view illustrating a second modification of the present embodiment.

As illustrated in FIG. 9B, the space 412 may be formed by a recess with a taper. This taper is formed in such a way as to become gradually farther away from the flexible wiring substrate 206 toward the non-fixed portion 422 from the fixed portion 421.

Each of the spaces 412 illustrated in FIGS. 9A and 9B widens from an inner side of the cover member 208 toward an outer side thereof. Hence, the air above the adhesive agent 410 protruding into the space 412 is not closed but is open to the ambient air. This configuration makes it easier to provide a portion to accommodate the adhesive agent 410 on the fixed portion 421.

FIG. 9C is a view illustrating a third modification of the present embodiment.

As illustrated in FIG. 9C, the space 412 may be a groove formed in the cover member 208.

In the present modification, a groove in a recessed shape that is farther away from the flexible wiring substrate 206 is formed in a portion of the cover member 208 overlapping the fixed portion 421 in the height direction of the liquid ejection head 101 in a cross-sectional view of the liquid ejection head 101.

FIG. 9D is a view illustrating a fourth modification of the present embodiment.

As illustrated in FIG. 9D, the space 412 may be a tapered groove formed in the cover member 208. In the present modification, a tapered groove with a taper that gradually becomes farther away from the flexible wiring substrate 206 is formed in the portion of the cover member 208 overlapping the fixed portion 421 in the height direction of the liquid ejection head 101 in a cross-sectional view of the liquid ejection head 101.

The configurations illustrated in FIGS. 9C and 9D ensure a certain thickness at an end portion of the cover member 208. This is advantageous for the rigidity of the cover member 208 against the capping of the cover member 208 with the cap member (not illustrated).

In all of FIGS. 9A to 9D, it is preferable for the space 412 to have such a volume as to accommodate an excess portion of the adhesive agent 410 to prevent the adhesive agent 410 from entering the non-fixed portion 422.

### Second Embodiment

A second embodiment of the technique of the present disclosure will now be described below with reference to drawings. In the following description, components which are similar or correspond to those in the first embodiment are denoted by the same names and reference signs and description thereof is omitted, and differences are mainly described.

The flexible wiring substrate 206 in the first embodiment is bent on the side where the contact wiring substrate 211 is attached. Alternatively, the flexible wiring substrate 206 may be bent along the surface of the channel member 201 facing the opposite direction from the surface to which the contact wiring substrate 211 is attached.

The present embodiment is aimed at providing a technique capable of bending the flexible wiring substrate 206 in such a manner as not to break it along the surface facing the opposite direction from the surface to which the contact wiring substrate 211 is attached.

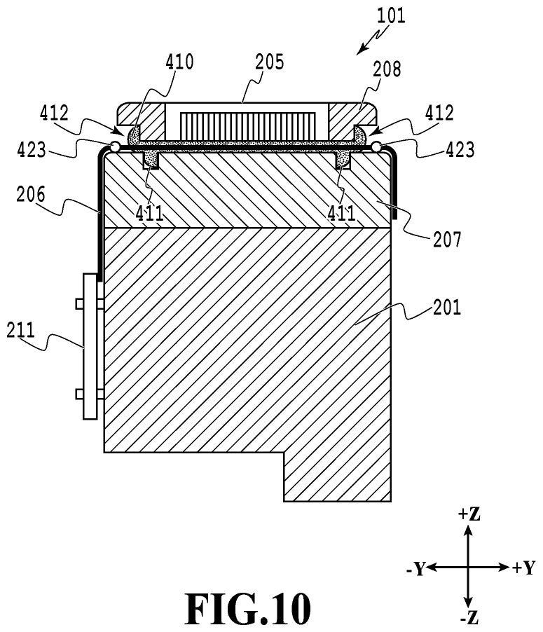

FIG. 10 is a schematic cross-sectional view of the liquid ejection head 101 applicable to the present embodiment.

As illustrated in FIG. 10, the flexible wiring substrate 206 in the present embodiment is bent also along the surface of the support member 207 facing the opposite direction from the surface to which the contact wiring substrate 211 is attached from the upper surface (the surface facing the +Z direction) of the support member 207. In the following description, the surface of the support member 207 facing the opposite direction from the surface to which the contact wiring substrate 211 is attached is referred to as “back surface.”In the present embodiment, a recess is formed as a space 412 also on the back surface side of the cover member. Moreover, a groove 411 is formed also in the upper surface (the surface facing the +Z direction) of the support member 207 on the back surface side relative to the element substrates 205. This configuration prevents the adhesive agent 410 from reaching the starting point 423 of the bend of the flexible wiring substrate 206 on the back surface side.

In a case where the adhesive agent 410 is applied in excess on the upper surface of the support member 207 on the back surface side of the support member 207 relative to the element substrates 205, the adhesive agent 410 gets accommodated into the groove 411 or the space 412 or both of them.

Accordingly, in the case of bending the flexible wiring substrate 206 along the back surface of the support member 207 from its upper surface, the flexible wiring substrate 206 will not be bent from a protruding portion of the adhesive agent 410 as a starting point.

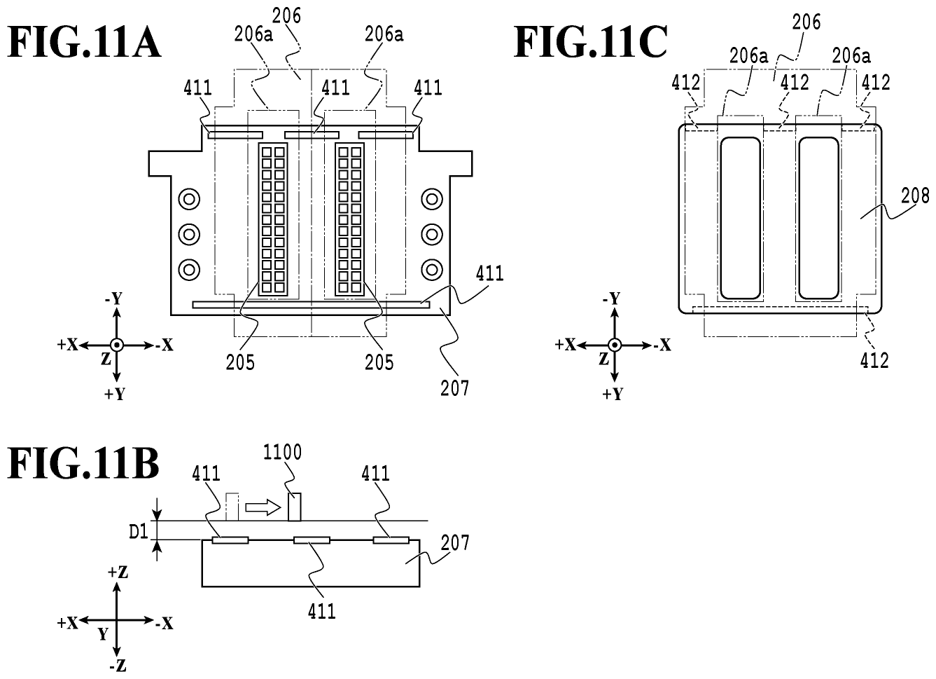

FIG. 11A is a schematic plan view of the liquid ejection head 101 applicable to the present embodiment. Note that FIG. 11A is a view of the liquid ejection head 101 illustrated in FIG. 10 as seen in the −Z direction from the +Z side in FIG. 10. Also, in FIG. 11A, the cover member 208 (see FIG. 10) is detached for convenience of description.

As illustrated in FIG. 11A, in a plan view of the bottom surface (the surface facing the near side in FIG. 11A) of the support member 207, three grooves 411 are formed along the X direction at an end portion of the bottom surface of the support member 207 in the −Y direction. One groove 411 is formed along the X direction at an end portion of the bottom surface of the support member 207 in the +Y direction.

In the flexible wiring substrate 206, through-holes 206a are formed penetrating through the flexible wiring substrate 206 in the Z direction in a state where the flexible wiring substrate 206 is bonded to the support member 207. With this configuration, the supply of the liquids from the support member 207 to the element substrates 205 will not be obstructed. The through-holes 206a partly overlap the bent portion of the flexible wiring substrate 206. That is, bending the flexible wiring substrate 206 also bends the through-holes 206a.

FIG. 11B is a schematic view of a process of applying the adhesive agent 410 applicable to the present embodiment.

As illustrated in FIG. 11B, in the present embodiment, a needle 1100 ejects and applies the adhesive agent 410 onto an application surface (the surface facing the +Z direction in FIG. 11B) of the liquid ejection head 101. The upper surface of the support member 207 and the flexible wiring substrate 206 laminated on the upper surface of the support member 207 are present at the application surface of the liquid ejection head 101. Thus, a distance D1 from the needle 1100 to the application surface of the liquid ejection head 101 changes depending on whether the flexible wiring substrate 206 is present or absent. This leads to a possibility of the adhesive agent 410 protruding particularly at portions where the flexible wiring substrate 206 is present.

FIG. 11C is a bottom view of the cover member 208 and the flexible wiring substrate 206 applicable to the present embodiment. For convenience of description, the bottom surface of the cover member 208 is illustrated as a transparent view. As mentioned above, there is a possibility of the adhesive agent 410 protruding at portions where the flexible wiring substrate 206 is present.

In the present embodiment, as illustrated in FIG. 11C, spaces 412 for preventing the adhesive agent 410 from protruding are formed in portions of the cover member 208 at which the cover member 208 and the flexible wiring substrate 206 overlap each other. It is preferable to form recesses as spaces 412 that can cover the entire width (the length in the X direction) of the flexible wiring substrate 206, for example.

As described above, with the technique of the present embodiment, the flexible wiring substrate 206 can be bent in such a manner as not to break along a surface facing the opposite direction from a surface to which the contact wiring substrate 211 is attached.

### Modification of Second Embodiment

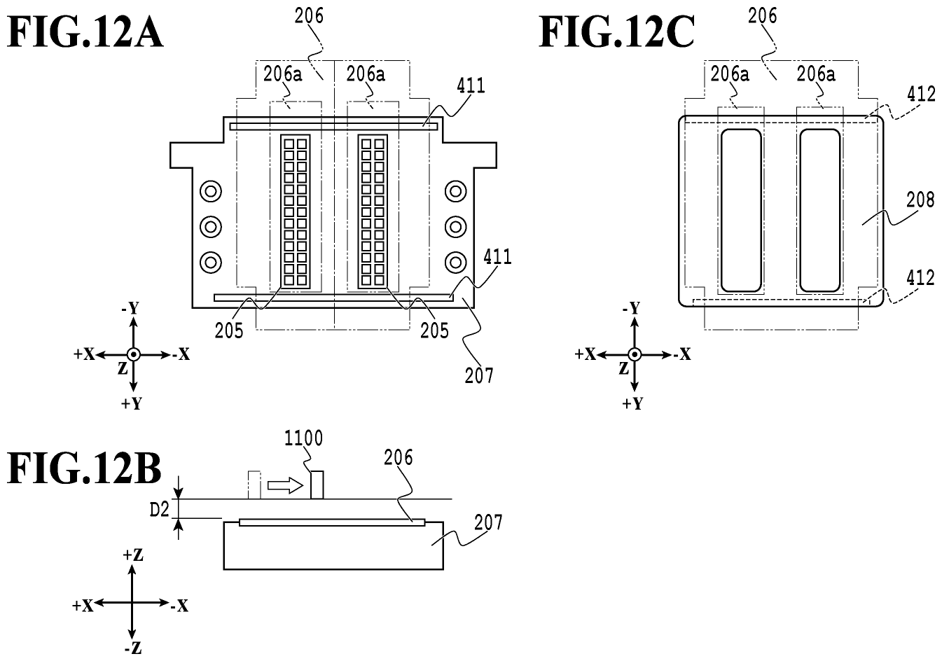

FIG. 12A is a schematic plan view of the liquid ejection head 101 applicable to a modification of the second embodiment. Note that FIG. 12A is a view of the liquid ejection head 101 illustrated in FIG. 10 as seen in the −Z direction from the +Z side in FIG. 10. Also, in FIG. 12A, the cover member 208 (see FIG. 10) is detached for convenience of description.

As illustrated in FIG. 12A, in a plan view of the bottom surface (the surface facing the near side in FIG. 12A) of the support member 207, one groove 411 is formed along the X direction at an end portion of the bottom surface of the support member 207 in the −Y direction. One groove 411 is formed along the X direction at an end portion of the bottom surface of the support member 207 in the +Y direction.

In the flexible wiring substrate 206, through-holes 206a are formed penetrating through the flexible wiring substrate 206 in the Z direction in a state where the flexible wiring substrate 206 is bonded to the support member 207. The through-holes 206a partly overlap the bent portion of the flexible wiring substrate 206. That is, bending the flexible wiring substrate 206 also bends the through-holes 206a.

Note that the grooves 411 in FIGS. 12A and 11A formed on the +Y side of the bottom surface of the support member 207 both have the same configuration.

FIG. 12B is a schematic view of a process of applying the adhesive agent 410 applicable to the present modification. Note that, in FIG. 12B, a description will be given assuming a case of applying the adhesive agent 410 to a portion of the flexible wiring substrate 206 that is not bent.

As illustrated in FIG. 12B, in the case of applying the adhesive agent 410 to a portion of the flexible wiring substrate 206 that is not bent, a distance D2 from the needle 1100 to the flexible wiring substrate 206 does not change.

FIG. 12C is a bottom view of the cover member 208 and the flexible wiring substrate 206 applicable to the present modification. For convenience of description, the bottom surface of the cover member 208 is illustrated as a transparent view.

As described above, in the present modification, the distance D2 from the needle 1100 to the flexible wiring substrate 206 does not change. Thus, in the present modification, it suffices that a space 412 is formed to cover the entire width (the length in the X direction) of the flexible wiring substrate 206, as illustrated in FIG. 12C. In the present modification, the groove 411 and the space 412 formed on the −Y side are larger than the grooves 411 and the spaces 412 formed on the −Y side in FIGS. 11A and 11B.

Accordingly, the groove 411 and the space 412 in the present modification can accommodate a larger amount of the adhesive agent 410 than the grooves 411 and the spaces 412 illustrated in FIGS. 11A and 11B. That is, the groove 411 and the space 412 in the present modification can increase the margin for the amount of the adhesive agent 410 to be applied.

### Third Embodiment

A third embodiment of the technique of the present disclosure will now be described below with reference to drawings. In the following description, components which are similar or correspond to those in the first and second embodiments are denoted by the same names and reference signs and description thereof is omitted, and differences are mainly described.

The cover member 208 and the contact wiring substrate 211 are attached to the liquid ejection heads 101 in the first and second embodiments. However, the cover member 208 and the contact wiring substrate 211 are not essential parts for the liquid ejection heads. According to the present embodiment, even a liquid ejection head without the cover member 208 and the contact wiring substrate 211 can improve reliability of its flexible wiring substrate.

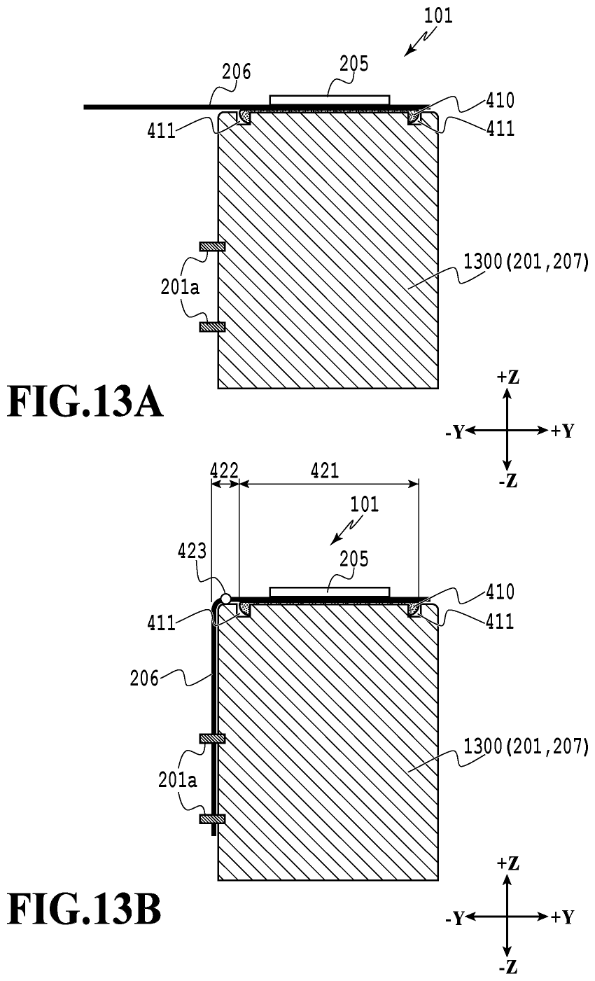

FIG. 13A is a schematic cross-sectional view of the liquid ejection head 101 applicable to the present embodiment. Note that the liquid ejection head 101 illustrated in FIG. 13A is in a state before the flexible wiring substrate 206 is bent.

As illustrated in FIG. 13A, the liquid ejection head 101 in the present embodiment includes a housing 1300 which is the channel member 201 and the support member 207 formed integrally with each other. The element substrates 205 and the flexible wiring substrate 206 are bonded to the upper surface of the housing 1300 by the adhesive agent 410. A groove 411 is formed at an end portion of the upper surface of the housing 1300 in the −Y direction and at an end portion of the upper surface in the +Y direction. Portions of the adhesive agent 410 that protruded at the time of bonding the element substrates 205 are accommodated in the grooves 411.

FIG. 13B is a schematic cross-sectional view of the liquid ejection head 101 applicable to the present embodiment. Note that the liquid ejection head 101 illustrated in FIG. 13B is in a state where the flexible wiring substrate 206 is riveted to the housing 1300.

As illustrated in FIG. 13B, the flexible wiring substrate 206 in the present embodiment is directly riveted to the housing 1300. The housing 1300 includes the pins 201a. While the flexible wiring substrate 206 is bent at a substantially right angle, the pins 201a are relatively inserted into openings formed in the flexible wiring substrate 206 and flattened.

In the present embodiment too, the flexible wiring substrate 206 has the fixed portion 421, to which the adhesive agent 410 is applied, and the non-fixed portion 422, to which the adhesive agent 410 is not applied. The starting point 423 for the bending of the flexible wiring substrate 206 is located within the non-fixed portion 422.

This prevents the flexible wiring substrate 206 from being bent on a protruding portion of the adhesive agent 410 as a starting point. Such a liquid ejection head can also improve reliability of its flexible wiring substrate.

### Other Embodiments

Examples to which the technique of the present disclosure is applicable have been described above. It is to be noted that the above description is not intended to limit the technique scope of the present disclosure. In each of the above embodiments, a thermal method is employed as an example in which liquids are ejected by causing printing elements (heaters) to generate bubbles. However, the technique of the present disclosure can be applied to liquid ejection heads employing a piezoelectric method that uses piezoelectric elements as the printing elements for ejecting the liquids and various other liquid ejection methods.

Note that the liquid ejection head of the present disclosure and a liquid ejection apparatus equipped with the liquid ejection head are applicable to apparatuses such as photocopiers, facsimiles having a communication system, and word processors having a printer unit. In addition to these, the liquid ejection head of the present disclosure and a liquid ejection apparatus equipped with the liquid ejection head are applicable to full-line inkjet printers including a liquid ejection head with a greater width than the width of the print medium. Further, the liquid ejection head of the present disclosure and a liquid ejection apparatus equipped with the liquid ejection head are applicable to industrial printing apparatuses combining various processing apparatuses. For example, the liquid ejection head of the present disclosure and a liquid ejection apparatus equipped with the liquid ejection head are usable in applications such as fabrication of biochips, printing of electronic circuits, and fabrication of semiconductor substrates.

The above embodiments are liquid ejection apparatuses configured to circulate liquids between tanks and a liquid ejection head, but may employ other configurations. For example, a configuration that circulates liquids between tanks and a liquid ejection head may be employed. Also, a configuration may be employed in which two tanks are provided upstream and downstream of the liquid ejection head and the liquids are caused to flow from one of the tanks to the other tank, instead of being circulated, to cause the liquids inside pressure chambers to flow.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-129865, filed Aug. 6, 2024, which is hereby incorporated by reference herein in its entirety.

According to the technique of the present disclosure, it is possible to improve reliability of a flexible wiring substrate.

What is claimed is:

1. A liquid ejection head comprising:
an element substrate configured to eject a liquid according to an electric signal;
a support member supporting the element substrate; and
a flexible wiring substrate fixed to the support member and configured to supply the electric signal to the element substrate, wherein
on a surface of the support member supporting the element substrate, the flexible wiring substrate includes a fixed portion fixed to the support member by an adhesive agent and a non-fixed portion not fixed to the support member, and
the flexible wiring substrate is bent from a position included in the non-fixed portion as a starting point.

2. The liquid ejection head according to claim 1, wherein a cover member configured to cover the flexible wiring substrate and having an opening through which to expose the element substrate is bonded to the flexible wiring substrate.

3. The liquid ejection head according to claim 2, wherein a space capable of accommodating the adhesive agent is formed in the cover member at a boundary between the fixed portion and the non-fixed portion.

4. The liquid ejection head according to claim 3, wherein the space is located between the starting point and the element substrate in a direction parallel to the surface.

5. The liquid ejection head according to claim 3, wherein the space is constituted by a recess formed in the cover member.

6. The liquid ejection head according to claim 5, wherein the recess has a curved shape.

7. The liquid ejection head according to claim 5, wherein the recess has a taper that gradually become farther away from the flexible wiring substrate toward the non-fixed portion from the fixed portion.

8. The liquid ejection head according to claim 5, wherein the recess is provided at an outer edge of the cover member.

9. The liquid ejection head according to claim 5, wherein the recess is a groove formed in the cover member.

10. The liquid ejection head according to claim 1, wherein a groove is formed in the support member between the starting point and the element substrate in a direction parallel to the surface.

11. The liquid ejection head according to claim 1, further comprising:
a contact wiring substrate electrically connected to the flexible wiring substrate; and
a housing having a first surface to which the contact wiring substrate is mounted and a second surface facing an opposite direction from the first surface, wherein
the fixed portion includes a first fixed portion and a second fixed portion different from the first fixed portion,
the non-fixed portion includes a first non-fixed portion and a second non-fixed portion different from the first non-fixed portion,
the first fixed portion and the first non-fixed portion are provided to be closer to the first surface than the element substrate is, and
the second fixed portion and the second non-fixed portion are provided to be closer to the second surface than the element substrate is.

12. The liquid ejection head according to claim 1, further comprising a channel member having a channel through which to supply the liquid to the element substrate, wherein
the support member has a first support surface supporting the channel member and a second support surface supporting the flexible wiring substrate and the element substrate.

13. A method for manufacturing a liquid ejection head that ejects a liquid, the method comprising the steps of:
bonding, to a support member, a flexible wiring substrate having flexibility and an element substrate configured to eject the liquid; and
bending a portion of the flexible wiring substrate which is not bonded to the support member, wherein
in the bonding, the flexible wiring substrate is bonded such that, on a surface of the support member supporting the element substrate, the flexible wiring substrate has a fixed portion fixed to the support member and a non-fixed portion not fixed to the support member, and
in the bending, the flexible wiring substrate is bent from a position included in the non-fixed portion as a starting point.

14. The method for manufacturing a liquid ejection head according to claim 13, further comprising the step of applying an adhesive agent to the support member before the bonding in such a way as to form the non-fixed portion and the fixed portion.

15. The method for manufacturing a liquid ejection head according to claim 13, wherein in the bonding, the flexible wiring substrate is bonded to the support member such that
the fixed portion includes a first fixed portion and a second fixed portion different from the first fixed portion,
the non-fixed portion includes a first non-fixed portion and a second non-fixed portion different from the first non-fixed portion,
the first fixed portion and the first non-fixed portion are provided on one side relative to the element substrate, and
the second fixed portion and the second non-fixed portion provided on another side relative to the element substrate.

16. The method for manufacturing a liquid ejection head according to claim 13, wherein the bending is preceded by bonding, to the flexible wiring substrate, a cover member configured to cover the flexible wiring substrate and having an opening through which to expose the element substrate.

17. The method for manufacturing a liquid ejection head according to claim 13, further comprising the step of connecting a contact wiring substrate having an electrical contact to the flexible wiring substrate.

18. The method for manufacturing a liquid ejection head according to claim 17, wherein the bending precedes the connecting.
